(19) United States
(12) Patent Application Publication
(10) Pub. No.: US 2020/0230902 A1
(43) Pub. Date: Jul. 23, 2020

(54) A MOLD FOR AN APPARATUS TO PRODUCE PLASTIC PIPE AND METHOD TO USE IT

(71) Applicant: Plastic Pipe Mobile OU, Pärnu (EE)

(72) Inventor: Seppo Takala, Pärnu (EE)

(21) Appl. No.: 16/640,038

(22) PCT Filed: Aug. 1, 2018
(86) PCT No.: PCT/FI2018/050563

§ 371 Date: Feb. 18, 2020

(30) Foreign Application Priority Data
Aug. 18, 2017 (FI) 20175740

(51) Int. Cl. B29D 23/00; F16L 9/16

(52) U.S. Cl. CPC B29D 23/001; B32B 1/08; F16L 9/16

(57) ABSTRACT

The invention is a mold (100) of an apparatus to produce plastic pipe that consists of the body (2) that has been supported to its place, the roll like roll organs (1.1) that have been supported to the body by the roll organs (3) that have been set to move the plastic pipe axially in its production process, additionally, it consists of at least four chain organs (1) the chains (1′) of each of which consist of the mentioned roll organs and joints (1.4) between them where each chain has been set to go round at least two chain wheels (1.2, 1.3) and each joint has been supported at the ends of its axis (1.6) to at least two like conductors (1.7) that have been set to conduct the mentioned circular motion of the chain and the conductors of each chain organ contain a part that is essentially in the same direction as the center axis (C) of the mold and the roll organ center axes that are in the place of these parts are in the same center line as the mold center axis and the mentioned roll organs have been set to be in contact with the inside surface or the outside surface of the plastic pipe during the production of the plastic pipe and at least one chain wheel of each chain organ has been set to be powered to rotate by motor power around its axis at such a speed and in such a direction that the roll organs that are in chain in the before mentioned position are able to move in the direction of the production of the plastic pipe at its production speed.

The object of this invention is a mold for an apparatus and a method to use it. The mentioned mold consists of a body that has been supported to its place and reel like rolling organs that have been made to move the plastic pipe in its production process axially.

The objects of the invention are the production processes of large plastic pipes. The large plastic pipes that can have the diameter of 1,000-6,000 mm or even larger are produced to be used for example in the production of large containers, drain pipes, road drums, water pipes etc. The most advanced production technique of these pipes is based on winding plastic ribbon or plastic profile upon a production apparatus mold with the rise of the width of the ribbon/profile and welding the screw joint that is formed water tight.

The molds with roll organs of the known technology have been made so that the roll organs are essentially of the same length as the molds and essentially rolls of the direction of the center axis of the mold and the pipe in the production and they form a circle where inner side of the pipe in production is in contact with the rolls. The rolls have been set to rotate around their center axis and thus the plastic ribbon or profile that is fed and the pipe in production are rolling upon the rolls.

One of the applications of the invention is to use the in itself known metal ribbon technique and its new invention usage a support layer upon the mold. This comes into question especially when a thin wall pipe is produced or the innermost layer of a multilayer pipe is produced using the mold of the invention.

In the patent publication WO 2014/080077 A1 there has been presented a solution like above first told roll technique solution. The rolls 2, 3 are of the same direction as the center axis of the plastic pipe in production and the plastic pipe is produced upon them. The pipe under production is forced into the movement of the direction of the process in production speed by the rolls of the direction of the radius of the mold.

In the patent publication PCT/JP88/01258 there has been presented another solution where the rolls 21a fainting the circle of the mold have been put to a certain small angle in relation to the middle line of the mold. With this setting, the plastic pipe in production can be made to move axially into its production direction without the radial pressure rolls of the previous solution.

The patent publication U.S. Pat. No. 4,081,302 presents a solution that is based on the before mentioned metal ribbon solution. A continuous looping steel ribbon is winded upon the form and the glass fiber is produced upon the layer of the steel ribbon. As the mold rotates this screw rise ribbon moves the pipe with itself. The ribbon has been set to return back to the beginning of the mold via the return wheels.

In the patent publication WO 2014/080077 A1 presented known technology solution has as its biggest disadvantages in the area that the radial rolls cause to the welding joint a variable pressure and thus an even quality welding joint is difficult. The longer the pipe is produced the greater the rotation resistance and the pressure in the welding joint.

The greatest disadvantage of the mold in the patent publication PCT/JP88/01258 is that there occurs sliding between the rolls and the pipe surfaces. To move the pipe in production requires that the move organ can move the pipe exactly at the speed of the production. The mentioned sliding causes trouble in the pipe production: The pipe does not move sufficiently in a certain time and thus the movement does not correspond the rise. This drawback leads for instance to constant need to adjust the welding head.

These before mentioned drawbacks have been tried to remove by the solution that has been presented in the patent publication FI 20160045. The central idea of this solution is to add to the end of the mold a separate move organ that moves the pipe in the production speed without sliding between the pipe and the moving organ.

This solution that in itself is advanced in relation to the technique it requires has as its drawback that it has a challenging construction. It has two separate apparatuses and the whole of it move organ included has been set to rotate together with the plastic pipe.

The intention of this invention is to get such a mold and method to produce plastic pipe that the drawbacks of the known technology are avoided. It is characteristic for the solution of the invention what has been presented in the characterizing parts of the claims 1 and 5.

The greatest advantage of this present invention in relation to the known technology can be seen that there occurs no sliding between inner side of the pipe in production and the moving organ that moves the plastic pipe into the production direction.

The mentioned advantage gives the concrete benefit that conditions of the joint achieved with the extruder welding can be held constant during the cooling. The pressing and stretching of the joint is avoided i.g. axial movement, and only the radial shrinking is allowed.

The before mentioned advantages give many practical benefits: precise measures, uniform welding quality, no need to calibrate welding head, the structure and the operation of the mold do not set restrictions for the length of the pipe in production.

In this document the term “roll organ” means a roll, roller, ball etc. that has been set to rotate in relation to the center line.

The term “plastic ribbon” means in this document a ribbon or a profile that has been made of plastic that is wound around the mold or inside it as a pipe or a part of it.

The invention is described in more detail in the enclosed drawings where;

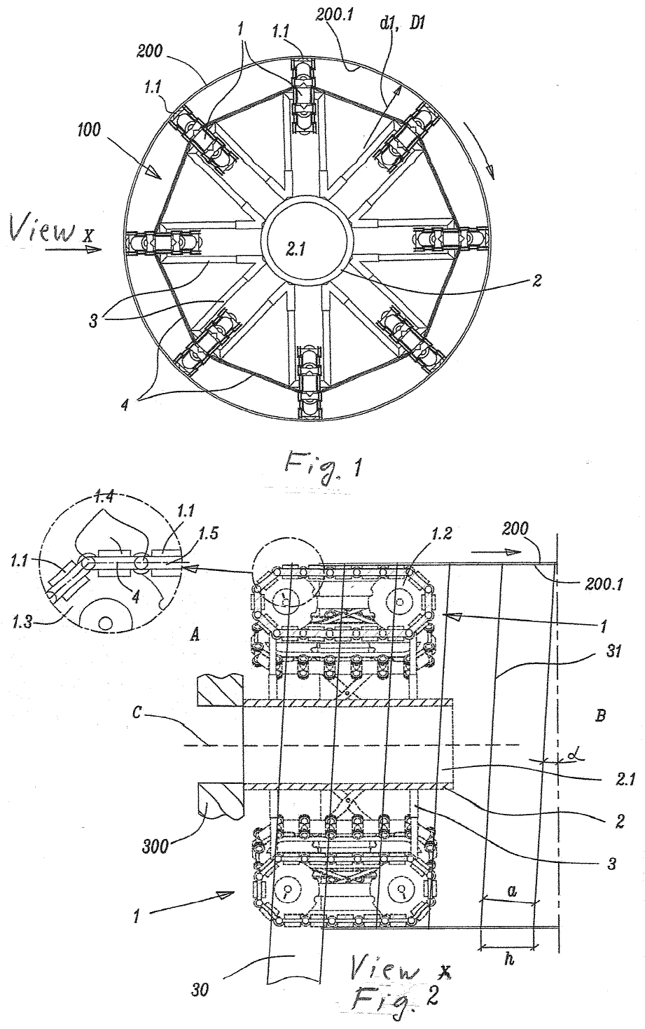

FIG. 1 presents a setting where there is a mold according to the invention in operation,

FIG. 2 presents the before mentioned setting seen from side;

FIG. 3 presents the chain organ of the mold in 3D,

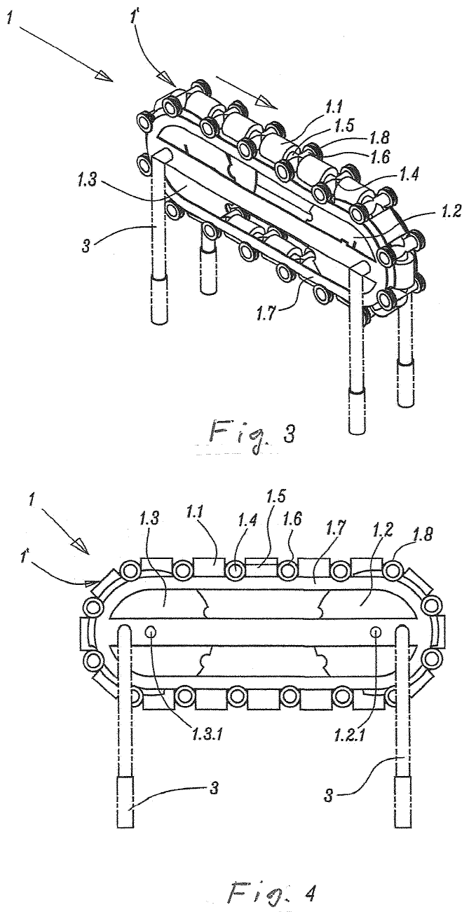

FIG. 4 presents the mentioned organ seen directly from side,

FIG. 5 presents the mold according to the invention in 3D,

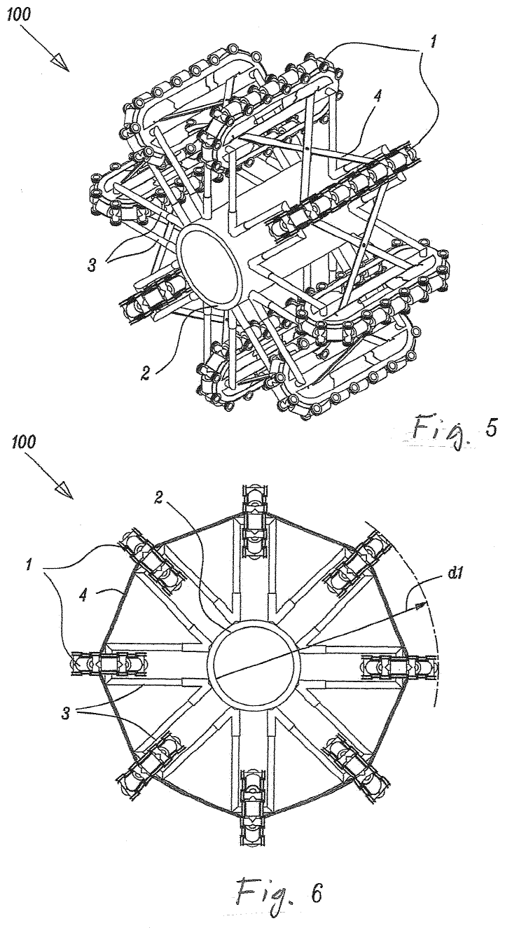

FIG. 6 presents the mold seen from the head,

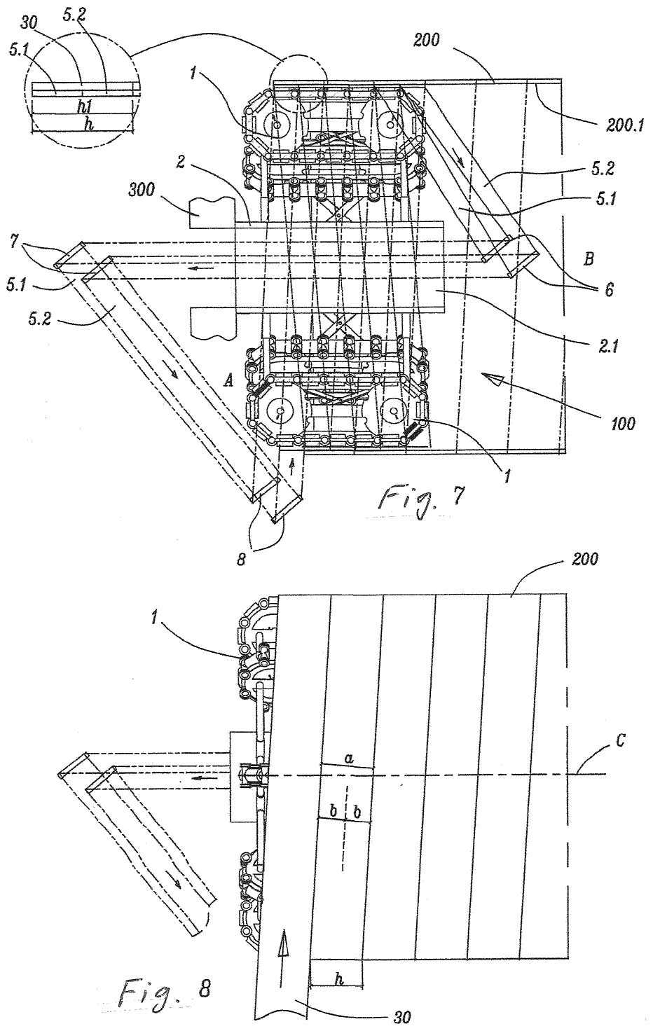

FIGS. 7 and 8 present another application form of the mold according to the invention,

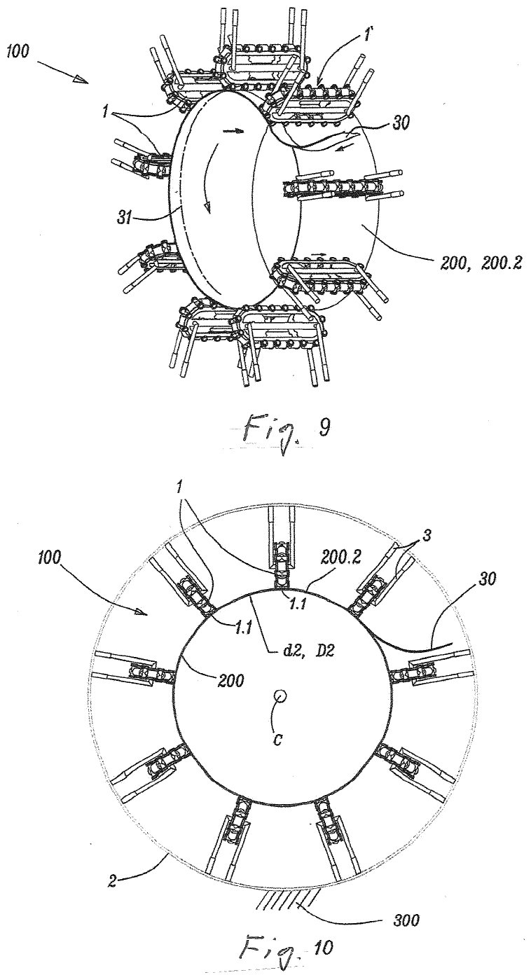

FIGS. 9 and 10 present an application of the mold according to the invention where the mold is outside the pipe.

Next, one for the invention favorable application construction and its usage will be described in the production process of the plastic pipe by referring to the before mentioned figs.

In FIGS. 1 and 2 there has been described the setting where the mold 100 according to the invention is used to produce plastic pipe 200. In this example, the pipe to be produced has thick walls and is pressure resistant pipe and it is made of plastic ribbon 30 that is fed to the mold tangentially and with a rise so that when the plastic ribbon is wound upon the mold its sides come against each other and a screw joint is formed between the sides. When this joint is welded the welding 31 makes the joint water tight. The outermost part of the mold 100 inside the forming plastic pipe consists of evenly distributed chain parts 1 in the circle that have been supported permanently to the pipe like mold body 2 with support organs 3. The body 2 is concentric with the plastic pipe 200 in production and it is supported to stay permanently in its place. The chain circle, the body and the plastic pipe have a common center axis C.

In FIGS. 3 and 4 there has been presented the mentioned chain organ 1 in more detail. The chain organ consists of the roll organs 1.1 that have been attached to the chain and the joints 1.4 between them and so they form roll organ chain 1 that has been set around the first and the second chain wheel 1.2, 1.3 to rotate around them. The chain has been set to turn between the side by side situated roll organ joints 1.4 with the chain wheels 1.2, 1.3. A part of the roll organs 1.1 that are reels in this example are always in chain lengthwise with the plastic pipe 200 (the direction of the roll center axis 1.5) and all the roll organs have been set to rotate freely around their center axes. The opposite ends of the center axes 1.5 of every two consequent roll organs have been connected to the joint 1.4 between them and the joint has been supported with the axis 1.6 to the conductors 1.7 alongside the roll organs in such a way that the chain parts 1.7 support against the inside surface of the plastic pipe 200 situated roll organs of the chain part to maintain certain pressure against the inside surface of the pipe. At the ends of the axes 1.6 there are grooved rolls 1.8 that move by the conductors 1.7. The first and the second chain wheels 1.2, 1.3 have been set to rotate around their center axes 1.2.1, 1.3.1 and at least one of the chain wheels has been set to rotate by motor power and at such a speed and direction that the roll organs 1.1 that are in connection with the inside surface of the plastic pipe move with the process speed of the plastic pipe 200 and into its production direction.

In FIGS. 5 and 6 there has been presented one realization of the mold 1 according to the invention. The body 2 of the mold is a horizontally placed tube like organ and it has been supported to its place to the production constructions 300 of the plastic pipe in the first end A of the feeding of the plastic ribbon 30. The chain accessories 1 have been set a ring around the body 2 concentrically and they have been supported to the body 2 with support organs 3. In this example, there are eight chain organs and the outside diameter d1 of the mold 100 can be adjusted and this adjustment is by regulating the lengths of the adjustable support organs 3. Additionally, every chain organ 1 has been connected to the adjacent chain organs with a connect organ 4. The connect organs operate in this example with the scissor principle and thus they support the chain organs to the same direction. The chain organs 1 and the connect organs 4 are locked to their places after adjustment.

The before mentioned mold 100 according to the invention works in the production process as follows:

Plastic ribbon 30 is fed to the mold 100 tangentially and with a rise of angle α between the ribbon and the normal of the center axis C in production and it winds around the outer circle of the roll organs 1.1 of the chains 1′ of the chain organs 1 forming a round ring (FIG. 2). The rise of the plastic ribbon 30 the width of which is “a” has been selected so that the opposite sides of the adjacent rounds join each other by a screw joint and this joint that can have the shape of for example V or X are joined together with a weld 31 and form a plastic pipe 200. The welding can be done inside the pipe or outside it or at the same time in both sides and the welding method defines the shape of the joint.

At the same time as the feeding of the plastic ribbon 30 begins the chain organs 1 are started. At least one chain roll 1.2, 1.3 is set to rotate around its axis by machine power with such a speed and into such a direction that the part of the chain 1′ that is against the plastic pipe moves at the production speed of the mentioned plastic pipe into the direction of the production of the pipe. The outside diameter d1 of the mold 100 defines the inside diameter D1 of the plastic pipe in production. The roll organs 1.1 rotate around its center axes 1.5 by motor power made rotate via the inside surface 200.1 of the plastic pipe 200 in production.

At the same time, the mentioned chain part roll organs 1.1 that are pressed against the inside surface 200.1 of the plastic pipe move the plastic pipe in its direction and into the direction of the center axis C of the mold while moving into the production direction of the pipe at its production speed. The pressure of the roll organs 1.1 is set such that there will exist no sliding between the mentioned parts.

A desired amount of the plastic pipe can be produced continuously with the mold 100 of the invention. It is possible to join different pipe treatment devices, e.g. a cutting device, to the production line.

In FIG. 7 there has been presented one solution of the invention, where there a support layer 5 is used upon the mold 100. When producing a pipe with a thin wall, like for example the innermost layer of a multilayer pipe it can be necessary to support the ring produced by the chain organs 1 to round shape. The support layer 5 consists here in the invention solution with two ribbons 5.1, 5.2 that are fed upon the mold side by side. The ribbons are fed tangentially and with such a rise that these two side by side touching ribbons form a solid layer upon the mold. The rise hl of the ribbon pair is the added width of two ribbons b+b divided by the feeding angle cosin (2*b/cos α). The ribbons 5.1, 5.2 are loops 100 without end from one end B via turn organ 6 through the hole 2.1 in body 2 and further via turn organs 7 and 8 back upon the mold in its first end A. The turn organs 6-8 can be for example rolls, rollers or wheels.

In FIG. 8 the support layer 5 of the ribbon pair upon the mold forms a basis upon which plastic ribbon 30 is fed with the rise h that is essentially the total width of the ribbons 5.1 and 5.2, total width b+b. The screw joint between the plastic ribbons is welded and the welding forms a water tight joint. The mentioned ribbon pair and the plastic ribbon can be set to advance upon each other or with a certain overlapping with each other.

It is also to set together more than two of the ribbons 5.1, 5.2. When using two or more ribbons 5.1, 5.2, etc. is different from the usage of one ribbon so that the width of the ribbons does not set limits for the rise hl because ribbons with great rise can return to the first end A of the mold separately and so the treatment of the ribbons in the turn organs 6-8 does not cause problems. It is common in the production of the plastic pipes 200 that the rise is considerably bigger than the rise with the traditional ribbon technique (one ribbon) production of the glass fiber pipes.

The ribbons 5.1, 5.2 can be made for instance of steel.

In FIGS. 9 and 10 there has been presented such an application of the mold 100 according to the invention where the chain organs 1 have been installed as a circle around the plastic pipe 200 in production in which case the plastic pipe is formed inside the mold 100. The inside diameter d2 is the diameter of the smallest possible circle of the roll organ 1.1 surfaces and it defines the outside diameter D2 of the plastic tube 200. There are nine chain organs in this example. The plastic ribbon 30 is fed tangentially to the inside diameter d2 of the mold in such a way that the opposite sides of the adjacent rounds are placed against each other as they wind against the roll organs and there is formed a screw joint between the rounds. The welding 31 is formed to this joint from inside the plastic pipe 200. It can also be formed at least partially from outside the pipe. Between the roll organs 1.1 and the outside surface 200.2, such a pressure is created that there will not be any sliding between them. The body 2 of the mold has been adopted in this solution of the invention outside the chain organ circle and fixed to the constructions 300 of the production place of the plastic pipe 200. The chain organs have been supported to the body with support organs 3. The inside diameter d2 of the mold can be adjusted by making the chain organ circle smaller or bigger and thus it is possible to produce plastic pipes 200 of different sizes.

Also this application of the invention makes it possible to produce multilayer pipes. The additional layers are produced inside the earlier made layer/s.

The plastic pipe 200 that is produced inside the mold 100 gets the rotation power from the pushing plastic ribbon and/or it can be rotated with motor power like for instance inside rolls.

The usage of the earlier described ribbons 5.1, 5.2 of the invention can be adapted also in the production of the plastic pipe 200 inside the mold 100. In this solution mentioned ribbons are fed against the roll organs 1.1 inside them and the ribbons are returned with the earlier mentioned return organs through outside from the second B of the mold 100 to its first end A. The plastic ribbon 30 is fed in this case through inside and inside the support layer 5 and against it.

The roll organs 1.1 can be realized as rolls, rollers or even balls. It is central for them that their roll parts that are in contact of the inside or outside are able to roll essentially with the same circle speed as the inside or outside surface of the mentioned pipe. The number of the roll organs in the chain 1′ can be realized apparatus by apparatus.

The chain wheels 1.3 can be connected to transfer the chain of the chain organ by any known method. As an example, it can be mentioned a grooving of the chain wheels that suits the joint axes 1.6 and their parting. The number of the chain wheels in the chain organ can be realized case by case and at least one chain wheel 1.2 is made a powered wheel. One favorable application of the invention is to set the second chain wheel 1.3 powered wheel that is the rear wheel in the plastic pipe in its advancing direction.

The rotation power of the chain wheel 1.3 and its power transfer to the chain wheel can be realized with the apparatus according to the invention in any known method. As an example an electric pole motor.

It is possible to put in connection of the chain 1′ a chain clamp and thus the chain that stretches in use can be kept in the desired tightness. The chain clamp can operate automatically.

The number of the chain organs 1 can be any suitable to the situation, e.g. 4-20. This does not limit their amount to this scale only. Likewise the size of the chain organ land the size of its parts can be adopted into each production process.

The length of the mold 100 can be individual. In the production of a one-layer pipe a shorter mold is suitable and in the production of a multilayer plastic pipe a longer mold can be used so that all the layers of the pipe can be added to the pipe either upon or inside the mold. As an example of a multilayer pipe we can mention a plastic pipe with reinforcement.

The mold radial movement of the chain organs 1 when changing the outer or inner diameter d1/d2 can also be made in some other way than what has been presented in one of the before mentioned examples. The adjustment can for instance be made automatically so the all the chain organs move at the same time and the same distance.

The same direction of the chain organs 1 can also be secured in some other way than what has been stated in the before mentioned example. When it is question about the presented scissor equipment the other ends of the scissors move when the chain organs are moved for instance along the grooves that have been adapted for them enabling the movement of the parts of the scissor in relation to each other and they can then be locked in a certain position. The other ends of the mentioned parts can thus be articulated to their places.

It should be noted that even though this presentation sticks only to one solution example that is favorable for the invention, this is not meant to limit the usage of the invention only to this type of solutions, instead, many variations are possible in the scope of the invention idea as defined in the claims.

1-12. (canceled)

13. A mold for an apparatus to produce plastic pipe that has been adapted for the production of the plastic pipe that rotates in the production process and that mold consists of:
a body that has been supported to its place;
the roll like roll organs that have been supported to the body by support organs and that have been set to move the plastic pipe axially in its production process;
at least four chain organs the chains of which consist of the mentioned roll organs and the joints between them, and where;
each chain has been set to go round at least two chain wheels;
each joint has been supported to its axis by two conductors that have been set to conduct the mentioned rotation movement of the chain wherein:
the mold has been set not to rotate with the plastic pipe in production,
the mold has been set to function inside or outside the plastic pipe,
the conductors of each chain organ consist of at least one essentially mold center axis direction part and the center axes of the roll organs that are at the location of these parts are parallel to the center axis of the mold and the mentioned roll organs have been set to be in contact with the inside surface or the outside surface of the plastic pipe and to rotate round its center axes during the production of the mentioned pipe,
at least one chain wheel of each chain organ has been set to be powered to move the chain and to rotate by the motor power around its axis at such a speed and in such a direction that the roll organs in the chain in such a place as defined in the position h) are able to move into the production direction of the plastic pipe in its production speed and as not gliding against the sur-face of the mentioned pipe can thus move the plastic pipe.

14. The mold according to the claim 13 wherein the outside diameter or inside diameter dimension has been set to be adjustable.

15. The mold according to the claim 14 wherein the outside diameter or the inside diameter has been set to be adjustable by adjusting the lengths of the support organs manually or automatically.

16. The mold according to the claim 13 wherein the body has a lengthwise opening through the body.

17. The mold to produce plastic pipe consisting of:
a body that has been supported to its place;
the roll like roll organs, that have been supported to the body by support organs and that have been set to move the plastic pipe axially in the production process;
at least four chain organs the chains of each of which consist of the mentioned roll organs and the joints between them, and where:
each chain has been set to go round at least two chain wheel;
each joint has been supported with its axis at the ends of the mentioned axis with at least two conductors that have been set to conduct the mentioned chain circular motion, wherein;
the mold has been set not to rotate with the plastic pipe in production,
the mold has been set to function inside or outside the plastic pipe;
there has been set a support layer on the outside diameter or inside diameter of the mold;
that consists at least of two loop like ribbons side by side that have been set to rotate on the mold with such a rise that it produces a sufficiently tight layers concerning the support of the surface of the mold; and
which ribbons have been set to return during the production process of the plastic pipe from the second end of the mold through the return organs via the opening in the body back to the first end of the mold in order to be fed tangentially back to the mold outside or inside;
the conductors of each chain organ consist essentially at least of one part that has the same direction as mold center axis and the center axes of the roll organs that are in the places of these parts are parallel to the center axis of the mold and the mentioned roll organs have been set to be in contact against the ribbons during the production of the mentioned pipe;
at least one chain wheel of each chain organ has been set to be a powered wheel to move the chain to rotate the wheel by motor around its center axis at such a speed and in such a direction that the roll organs that have been defined in the previous position are able to move into the production direction of the plastic pipe at the production speed and thus make the plastic pipe move.

18. The mold according to the claim 17 wherein the outside diameter or inside diameter has been set to be adjustable of its dimension.

19. The mold according to the claim 17 wherein the outside diameter or the inside diameter has been set adjustable either by changing the length of the support organs manually or automatically.

20. The mold according to some of the claim 13 wherein the roll organs are rolls having axis.

21. The mold according to some of the claim 13 wherein the chain wheels have been connected to the chain with the compatibility of the grooves in the chains and the joint axes.

22. The mold according to some of the claim 13 wherein there is a pole motor connected to the powered chain wheel or some other power source according to the known technique.

23. A method to use the mold of the apparatus to produce plastic pipe in which method the plastic pipe in production is supported and it is moved in the direction of the center axis into its production direction, wherein the mold according to claim 13 is used.

24. The mold according to some of the claim 17 wherein the roll organs are rolls having axis.

25. The mold according to some of the claim 17 wherein the chain wheels have been connected to the chain with the compatibility of the grooves in the chains and the joint axes.

26. The mold according to some of the claim 17 wherein there is a pole motor connected to the powered chain wheel or some other power source according to the known technique.

27. A method to use the mold of the apparatus to produce plastic pipe in which method the plastic pipe in production is supported and it is moved in the direction of the center axis into its production direction, wherein the mold according to claim 17 is used.

28. The method according to the claim 23 wherein the method used to produce one-layered or multilayered plastic pipe either in the inside or the outside of the mold and that the inside diameter of the plastic pipe is at least one meter.
